(19) United States
(12) Patent Application Publication
(10) Pub. No.: US 2014/0040239 A1
(43) Pub. Date: Feb. 6, 2014

(54) LIVE EVENT INFORMATION MANAGEMENT SYSTEM

(71) Applicant: Mary P. Hirsch, San Francisco, CA (US)

(72) Inventor: Mary P. Hirsch, San Francisco, CA (US)

(73) Assignee: CBS, INTERACTIVE, INC., San Francisco, CA (US)

(21) Appl. No.: 13/593,452

(22) Filed: Aug. 23, 2012

Related U.S. Application Data
(60) Provisional application No. 61/679,411, filed on Aug. 3, 2012.

(51) Int. Cl. G06F 17/30

(52) U.S. Cl. CPC G06F 17/30386
USPC 707/722

(57) ABSTRACT

An organization data management system is described. A method may comprise receiving organization information, by a processor accessible by a server computing device, associated with a sports organization; relating statistics, received by the processor, associated with one or more events involving the sports organization to the organization information, the statistics being related to provide statistics levels comprising at least game, season, and career statistics levels; generating one or more customized reports comprising the statistics and the organization information; and presenting the statistics and the organization information on a user interface accessible from a display of a client computing device. Other embodiments are described and claimed.

### CROSS-REFERENCE TO RELATED APPLICATIONS

This application claims the benefit of, and priority to, commonly owned and co-pending U.S. Provisional Patent Application Ser. No. 61/679,411 entitled “LIVE EVENT INFORMATION MANAGEMENT SYSTEM” filed on Aug. 3, 2012, which is hereby incorporated by reference in its entirety.

This application is related to commonly owned and co-pending U.S. patent application Ser. No. 13/483,748 entitled “LIVE EVENT INFORMATION REPORTING SYSTEM” filed on May 30, 2012, which is hereby incorporated by reference in its entirety.

### BACKGROUND

Professional sports, such as the National Football League (NFL®) and Major League Baseball (MLB®), gather volumes of highly detailed statistics. Sports fans and participants at all levels, including the collegiate, high school, amateur, and small-audience levels have demonstrated a tremendous interest, and have even come to expect, available statistics for their particular sport similar to that for the professional level. However, unlike professional sports, other sports leagues and associations do not have the assets or infrastructure to gather statistics for their games at such a scale or level of detail. In addition, even if non-professional sports entities could gather such statistics, they lack the ability to efficiently manage the statistics to provide them in a meaningful platform for interested users.

Nonetheless, non-professional and small-audience sports, are often followed by a passionate fan base that seeks real-time statistics parallel to that provided for the large professional sports organizations. Various content providers, such as web site operators, may benefit from providing efficient and meaningful access to highly-detailed statistics pertaining to non-professional and small-audience sports, for example, through increased web site traffic, increased online advertising revenue, and building a loyal following drawn from the local and small-audience fan base. As such, techniques designed to gather and manage a large volume of highly-detailed statistics for non-professional and small-audience events would be highly desirable.

### BRIEF DESCRIPTION OF THE DRAWINGS

FIG. 1 illustrates an embodiment of an organization data management system.

FIG. 2 illustrates an embodiment of a first operating environment for an organization data management application.

FIG. 3 illustrates an embodiment of a second operating environment for an organization data management application.

FIG. 4 illustrates an embodiment of a third operating environment for an organization data management application.

FIG. 5 illustrates an embodiment of a fourth operating environment for an organization data management application.

FIG. 6 illustrates an embodiment of a fifth operating environment for an organization data management application.

FIG. 7 illustrates an embodiment of a sixth operating environment for an organization data management application.

FIG. 8 illustrates an embodiment of a seventh operating environment for an organization data management application.

FIG. 9 illustrates an embodiment of a eighth operating environment for an organization data management application.

FIG. 10 illustrates an embodiment of a ninth operating environment for an organization data management application.

FIG. 11 illustrates an embodiment of a tenth operating environment for an organization data management application.

FIG. 12 illustrates an embodiment of an eleventh operating environment for an organization data management application.

FIG. 13 illustrates an embodiment of a twelfth operating environment for an organization data management application.

FIG. 14 illustrates an embodiment of a first logic flow.

FIG. 15 illustrates an embodiment of a second logic flow.

FIG. 16 illustrates an embodiment of a third logic flow.

FIG. 17 illustrates an embodiment of a computing architecture.

FIG. 18 illustrates an embodiment of a communications architecture

### DETAILED DESCRIPTION

User demand for efficient, meaningful access to highly-detailed statistics for non-professional and small-audience events, such as collegiate and high school sports, is largely not being met. Large media broadcasters, sports leagues, and content providers such as the Cable News Network (CNN®), CBS Sports®, the Entertainment and Sports Programming Network (ESPN®), NFL®, and MLB® only provide real-time information directed towards news and sports events having widespread appeal and national audiences. These and other similar organizations have limited resources and only dedicate their infrastructure, technology, and personnel to cover popular events that will earn an adequate return on their investment. As a result, less popular and lower revenue generating events are not covered in a manner that provides users with access to highly-detailed data about the events. In addition, users are less likely to have access to information in a meaningful and efficient form, such as reporting, website presentation, and various statistics levels, such as game, season, and career. Exemplary non-professional and small-audience events include regional sporting events and events having a limited following compared to popular sporting events such as Major League Baseball® (MLB®) games, including high school sports, college sports, and small-audience sports such as swimming, diving, lacrosse, and cycling.

Although non-professional and small-audience events do not have widespread, national audiences, they are often followed by dedicated, passionate fan bases that seek information in a manner similar to that provided for events of mass appeal. As such, it would be beneficial to provide an efficient, accurate, and cost-effective technique for providing meaningful and efficient access to statistics and other information associated with non-professional and small-audience events.

Accordingly, various embodiments are generally directed to techniques for collecting, managing, and reporting statistics associated with live events. Some embodiments are particularly directed to systems configured to create data systems for organizations involved in the live events and relating the statistics with various aspects of the organizations. For example, an organization may involve a sports organization, such as one or more leagues, teams, athletic associations, and combinations thereof. Embodiments provide architecture and information structures for generating virtual organizations, such as sports organizations, that may be associated with information about the organization and statistics generated based on live events involving the organizations. For instance, an organization may comprise a baseball league having multiple teams. Embodiments may provide techniques for managing the baseball league and information associated with the baseball league, such as teams, rosters, schedules, game statistics, and individual statistics. In one embodiment, data associated with the organizations may be structured so as to be shared between leagues, teams, a central organization, and platforms (e.g., website, reporting software, data entry software).

In this manner, organization administrators may have access to efficient, effective systems for managing organization information and statistics related thereto and the general public may have access to a wide range of statistics that might not otherwise be available. System architectures and user interfaces configured according to embodiments provide for simple and efficient management and configuration of organization information and statistics, as well as providing standard data formats for content consumers. This significantly reduces the time and effort required to manage and provide information for an organization and related sub-entities, thereby enhancing convenience, user experience, and the availability of information.

With general reference to notations and nomenclature used herein, the detailed description which follows may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. These apparatus may be specially constructed for the required purpose or may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

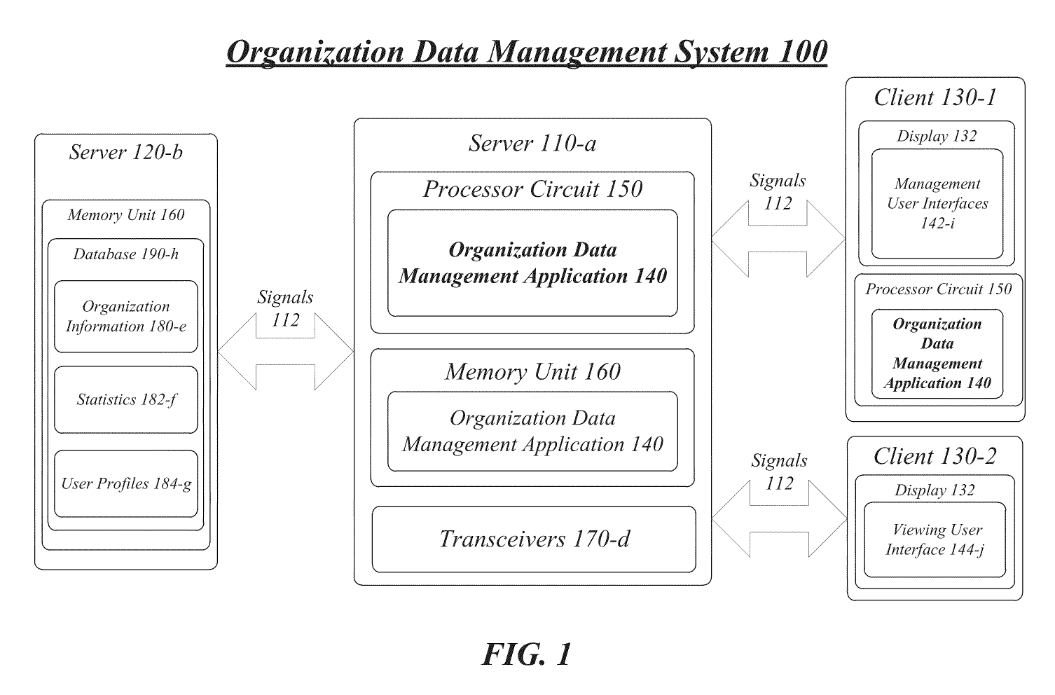

FIG. 1 illustrates a block diagram for an organization data management system 100. In one embodiment, the organization data management system 100 may comprise a computer-based system comprising a server 110-a. The server 110-a may comprise, for example, a processor circuit 150, a memory unit 160, and one or more transceivers 170-d. The server 110-a may further have installed an organization data management application 140. The memory unit 160 may store an unexecuted version of the organization data management application 140. Although the organization data management system 100 shown in FIG. 1 has a limited number of elements in a certain topology, it may be appreciated that the organization data management system 100 may include more or less elements in alternate topologies as desired for a given implementation.

It is worthy to note that “a,” “b,” “c” and similar designators as used herein are intended to be variables representing any positive integer. Thus, for example, if an implementation sets a value for b=3, then a complete set of servers 120-b may include servers 120-1, 120-2, and 120-3. The embodiments are not limited in this context.

In various embodiments, the organization data management system 100 may comprise multiple computing devices, such as servers 110-a, 120-b and clients 130-c. Some examples of a computing device may include without limitation an ultra-mobile device, a mobile device, a personal digital assistant (PDA), a mobile computing device, a smart phone, a telephone, a digital telephone, a cellular telephone, eBook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, machine, or combination thereof. The embodiments are not limited in this context.

In one embodiment, for example, servers 110-a and 120-b may be implemented as a web server and a network server, respectively, accessible over a network, such as the Internet. In another embodiment, servers 110-a and 120-b may be arranged in a distributed computing environment (e.g., a “cloud” or “cloud computing environment”). The client 130-c may be implemented as a desktop computer or a mobile device having a portable power supply and wireless communications capabilities, such as a laptop computer, handheld computer, tablet computer, smart phone, gaming device, consumer electronic, or other mobile device. The embodiments are not limited to these examples, however, and any servers 110-a, 120-b and clients 130-c may be used as desired for a given implementation. The servers 110-a may communicate with other computing devices 120-b, 130-c using communications signals 112 via the transceivers 170-d. The embodiments are not limited in this context.

In various embodiments, the organization data management system 100 may comprise a processor circuit 150. The processor circuit 150 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Core (2) Quad®, Core i3®, Core i5®, Core i7®, Atom®, Itanium®, Pentium®, Xeon®, and XScale® processors; and similar processors. Dual microprocessors, multi-core processors, and other multi-processor architectures may also be employed as the processor circuit 150.

In various embodiments, the organization data management system 100 may comprise a memory unit 160. The memory unit 160 may store, among other types of information, the organization data management application 140 or one or more databases 190-h. The memory unit 160 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Users may access a management user interface 142-i and a viewing user interface 144-j through display 132 of a client 130-1, 130-2. The display 132 may comprise any digital display device suitable for the one or more clients 130-c. For instance, the display 132 may be implemented by a liquid crystal display (LCD) such as a touch-sensitive, color, thin-film transistor (TFT) LCD, a plasma display, a light emitting diode (LED) display, an organic light emitting diode (OLED) display, a cathode ray tube (CRT) display, or other type of suitable visual interface for displaying a user interface 142, 144 to a user of the one or more clients 130-c. The display 132 may further include some form of a backlight or brightness emitter as desired for a given implementation.

In various embodiments, the servers 110-a may comprise one or more transceivers 170-d. Each of the transceivers 170-d may be implemented as wired transceivers, wireless transceivers, or a combination of both. In some embodiments, the transceivers 170-d may be implemented as physical wireless adapters or virtual wireless adapters, sometimes referred to as “hardware radios” and “software radios.” In the latter case, a single physical wireless adapter may be virtualized using software into multiple virtual wireless adapters. A physical wireless adapter typically connects to a hardware-based wireless access point. A virtual wireless adapter typically connects to a software-based wireless access point, sometimes referred to as a “SoftAP.” For instance, a virtual wireless adapter may allow ad hoc communications between peer devices, such as a smart phone and a desktop computer or notebook computer. Various embodiments may use a single physical wireless adapter implemented as multiple virtual wireless adapters, multiple physical wireless adapters, multiple physical wireless adapters each implemented as multiple virtual wireless adapters, or some combination thereof. The embodiments are not limited in this case.

The wireless transceivers 170-d may comprise or implement various communication techniques to allow the servers 110-a to communicate with other electronic devices, such as the servers 120-b and the clients 130-c. For instance, the wireless transceivers 170-d may implement various types of standard communication elements designed to be interoperable with a network, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

In various embodiments, the servers 110-a may implement different types of transceivers 170-d. Each of the transceivers 170-d may implement or utilize a same or different set of communication parameters to communicate information between various electronic devices. In one embodiment, for example, each of the transceivers 170-d may implement or utilize a different set of communication parameters to communicate information between the servers 110-a and one or more remote devices, such as remote servers 120-b and remote clients 130-c. Some examples of communication parameters may include without limitation a communication protocol, a communication standard, a radio-frequency (RF) band, a radio, a transmitter/receiver (transceiver), a radio processor, a baseband processor, a network scanning threshold parameter, a radio-frequency channel parameter, an access point parameter, a rate selection parameter, a frame size parameter, an aggregation size parameter, a packet retry limit parameter, a protocol parameter, a radio parameter, modulation and coding scheme (MCS), acknowledgement parameter, media access control (MAC) layer parameter, physical (PHY) layer parameter, and any other communication parameters affecting operations for the transceivers 170-d. The embodiments are not limited in this context.

In one embodiment, for example, the transceiver 170-d may comprise a radio designed to communicate information over a wireless local area network (WLAN), a wireless metropolitan area network (WMAN), a wireless wide area network (WWAN), or a cellular radiotelephone system. The transceiver 170-d may be arranged to provide data communications functionality in accordance with different types of longer range wireless network systems or protocols. Examples of suitable wireless network systems offering longer range data communication services may include the IEEE 802.xx series of protocols, such as the IEEE 802.11a/b/g/n series of standard protocols and variants, the IEEE 802.16 series of standard protocols and variants, the IEEE 802.20 series of standard protocols and variants (also referred to as “Mobile Broadband Wireless Access”), and so forth. Alternatively, the transceiver 170-d may comprise a radio designed to communication information across data networking links provided by one or more cellular radiotelephone systems. Examples of cellular radiotelephone systems offering data communications services may include GSM with General Packet Radio Service (GPRS) systems (GSM/GPRS), CDMA/1xRTT systems, Enhanced Data Rates for Global Evolution (EDGE) systems, Evolution Data Only or Evolution Data Optimized (EV-DO) systems, Evolution For Data and Voice (EV-DV) systems, High Speed Downlink Packet Access (HSDPA) systems, High Speed Uplink Packet Access (HSUPA), and similar systems. It may be appreciated that other wireless techniques may be implemented, and the embodiments are not limited in this context.

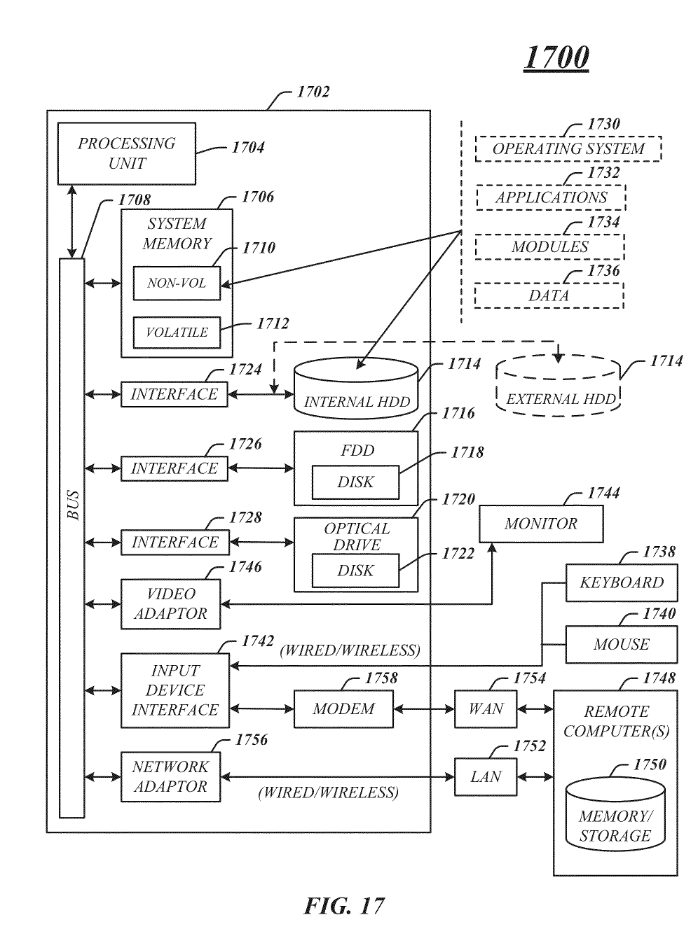

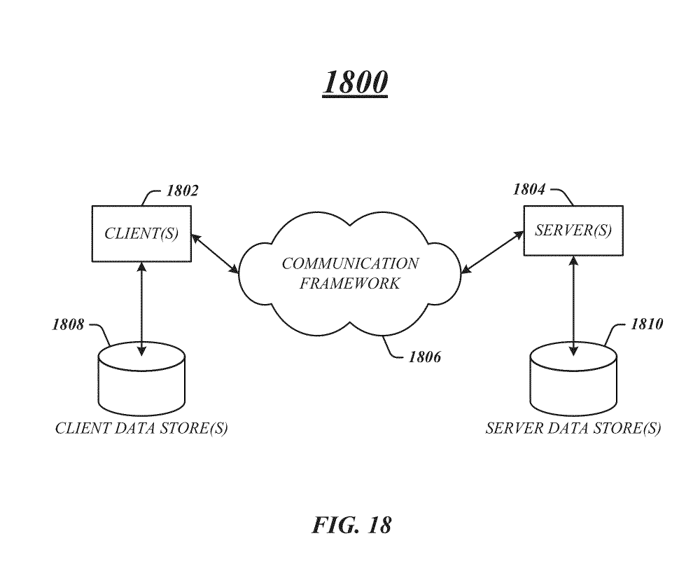

Although not shown, the servers 110-a, 120-b and clients 130-c may further comprise one or more device resources commonly implemented for electronic devices, such as various computing and communications platform hardware and software components typically implemented by a personal electronic device. Some examples of device resources may include without limitation a co-processor, a graphics processing unit (GPU), a chipset/platform control hub (PCH), an input/output (I/O) device, computer-readable media, display electronics, display backlight, network interfaces, location devices (e.g., a GPS receiver), sensors (e.g., biometric, thermal, environmental, proximity, accelerometers, barometric, pressure, etc.), portable power supplies (e.g., a battery), application programs, system programs, and so forth. Other examples of device resources are described with reference to exemplary computing architectures shown by FIGS. 17-18. The embodiments, however, are not limited to these examples.

In the illustrated embodiment shown in FIG. 1, the processor circuit 150 may be communicatively coupled to the transceiver 170-d and the memory unit 160. The memory unit 160 may store an organization data management application 140 arranged for execution by the processor circuit 150 to manage data such as organization information 180-e and statistics 182-f, and to present a user interface 142-i, 144-j to one or more clients 130-c through communication signals 112 via the transceivers 170-d. The servers 120-b and clients 130-c may implement similar elements as the servers 110-a, including a processor circuit 150, a memory unit 160, and transceivers 170-d. For example, servers 120-b may be comprised of a memory unit 160 storing data such as organization information 180-e, statistics 182-f, user profiles 184-g, or some combination thereof, for example, in one or more databases 190-h.

The organization data management application 140 may generally provide features to present various management user interfaces 142-i configured to allow a user to manage organization information 180-e and/or statistics 182-f. For example, the management user interfaces 142-i, may provide for data entry, management, editing, and other organization administration functions The organization data management application 140 may additionally provide features to present various viewing user interfaces 144-j configured to allow users to view and interact with organization data and statistics 182-f. For instance, the viewing user interfaces 144-j may provide users with websites configured to display organization information 180-e and associated statistics 182-f according to user directives. In one embodiment, the viewing user interface 144-j may comprise a report generated presenting organization information 180-e and associated statistics 182-f according to a reporting format.

The management user interface 142-i may be configured specifically for the management of organization information 180-e characteristic for the type of organization, such as a particular sports league, including, but not limited to, football, basketball, baseball, softball, ice hockey, field hockey, soccer, wrestling, and lacrosse leagues, at various levels, such as the collegiate, grade school, and amateur levels. In a non-limiting example, a user may access the management user interface 142-i utilizing a smart phone client 130-c device and perform various management functions, such as data sharing, importing, exporting, sharing, verifying, and sending to a central organization (e.g., the National Collegiate Athletic Association (NCAA®)).

The organization information 180-e may comprise information associated with the organization and/or configured to describe the organization and any related entities. For example, for a sports organization, such as a collegiate athletic association, organization information 180-e may include, without limitation, school names, school profile, teams, team names (i.e., nicknames), divisions, conferences, rosters (e.g., players, player identification information, jersey numbers, positions, year, eligibility year, etc.), schedules, organization identifications (e.g., league ID numbers, codes, NCAA® RPI code, etc.), and game information (e.g., dates, times, location, stadium, officiating information). The statistics 182-f may comprise information associated with events involving the organizations, such as games for a sports organization. As such, the statistics 182-f may be determined based on the particular sport and certain aspects of the organization. For example, for baseball, statistics 182-f may include at bats, hits, batting average, hits, runs, stolen bases, caught stealing, earned run average, innings pitched, scores, wins, and losses. According to embodiment, statistics 182-f may be associated with the organization information 180-e such that entry of statistics 182-f may be related to the correct organization entity (e.g., player, team) and may be compiled with any other statistics 182-f previously entered into the system. In this manner, statistics 182-f may be compiled and viewed at various levels, including the individual player, team, and league levels over various time periods, such as a single game, season, and career and in comparison with other statistics 182-f, for instance, to generate high/low information, records, customized statistics (e.g., WHIP in baseball), and player, team, and league comparisons.

The organization information 180-e and the statistics 182-f may comprise any defined set of electronic information, data, or content capable of being uniquely identified, presented by a user interface 142-i, 144-j, or represented by a user interface element of a user interface 142-i, 144-j. One exemplary class of content organization information 180-e or statistics 182-f may include, without limitation, software computer files, including application files (e.g., document files, word processing files, spreadsheet files, presentation files, etc.), system files (e.g., operating system files, library files, utility files, etc.), and multimedia content files (e.g., audio files, video files, audio/video files, picture files, image files, etc.). Other examples of organization information 180-e or statistics 182-f may include without limitation objects presented by a user interface 142-i, 144-j, user interface elements, GUI elements, multimedia content (e.g., pictures, images, video, audio, graphics, games, discussion forums, blogs, contests, etc.), software programs, views of software programs, application documents, application content (e.g., a paragraph from a word processing document or work sheet from a spreadsheet document), a web page, a web site, a uniform resource locator (URL) from a web browser, clipboard data, screenshots, device resource data (e.g., sensor data), and so forth. These are merely a few examples, and any type of defined set of electronic information, data, or content may comprise organization information 180-e or statistics 182-f as utilized in the organization data management system 100.

Organization information 180-e entered via a management user interface 142-i may be transmitted via communication signals 112 to the organization data management application 140 operating on the server 110-a. According to embodiments, the organization data management application 140 may operate to store the organization information 180-e in a memory unit 160 or on another server 120-b or to present the organization information 180-e, in combination with any associated statistics 182-f, on a display 132 of a client 130-c computing device through a viewing user interface 144-j. In one embodiment, clients 130-c may access the viewing user interface 144-j through a thin-client application and any associated thin-client hardware accessible by the client 130-c, including, but not limited to, ultra-thin client, web thin client, and mobile thin client implementations, or through a web browser user interface, including without limitation Microsoft® Internet Explorer®, Mozilla® Firefox®, Apple® Safari®, and Google Chrome™ browser applications. In a further embodiment, the client 130-b may execute its own version of the organization data management application 140, such as a mobile application (“app” or “mobile app”) version of the organization data management application 140 which communications with the server 110-a through signals 112.

Users may register with the organization data management system 100, for example, through the creation of user profiles 184-g associated with login credentials (i.e. user name and password) and user profile information (e.g., name, address, phone number, email address, historical data). In one embodiment, users may be granted different levels of access to the organization data management application 140 and data associated therewith (e.g., organization information 180-e and statistics 1824). For example, certain users may be administrators having full access, other users may have limited administrative access (e.g., they may enter statistics, but may not edit organization information, or vice versa), while still others may only have viewing access (e.g., a member of the general public may register with the organization data management system 100 to access a viewing user interface 144-j comprising a team website displaying statistics 182-f for the organization). Embodiments are not limited in this context.

In one embodiment, the clients 130-c may execute a version (e.g., a client version or mobile application version) of the organization data management application 140 through a processor circuit 150 resident on one of the clients 130-c. As such, the version of the organization data management application 140 operating on the servers 110-a may communicate with the version of the organization data management application 140 operating on the client to, inter alia, obtain user credentials, to receive organization information 180-e, and to provide statistics 182-f. In another embodiment, the clients 130-c may interact with the servers 110-a and 120-b through one or more web service APIs configured to provide access to system data 180-e, 182-f and user interfaces 142-i, 144-j.

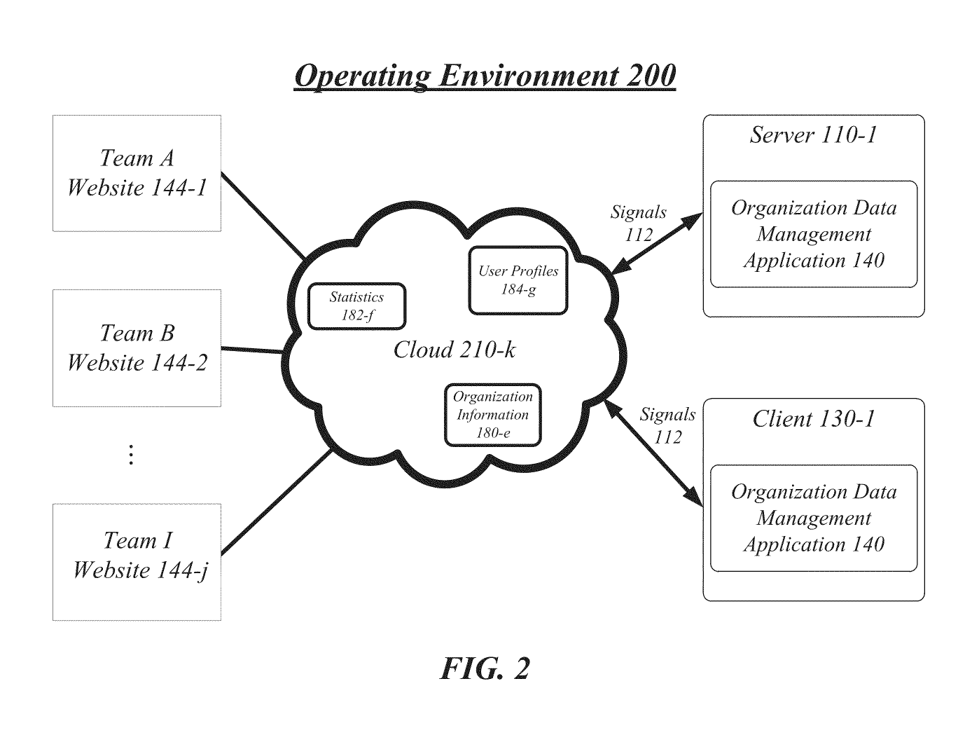

Particular aspects, embodiments and alternatives of the organization data management system 100 and the organization data management application 140 may be further described with reference to FIG. 2.

FIG. 2 illustrates an embodiment of an operating environment 200 for the organization data management system 100. More particularly, the operating environment 200 may illustrate a distributed computing environment embodiment for the organization data management system 100.

As shown in FIG. 2, the organization data management system 100 may comprise a distributed computing environment arranged as a cloud computing environment 210-k. Data, such as organization information 180-e, statistics 182-f, and user profiles 184-g may be stored in one or more clouds 210-k. In one embodiment, the organization information 180-e, statistics 182-f, and user profiles 184-g may be stored in one cloud 210-k, multiple clouds 210-k, each in a separate cloud 210-k, or combinations thereof. The organization data management application 140 operating on a server 110-1 or a client 130-1 may communicate with the cloud via signals 112, for example, transmitting or receiving the organization information 180-e, statistics 182-f, and user profiles 184-g.

According to embodiments, each organization entity in the organization data management system 100 may interact with the cloud 210-k and data contained therein. For example, an organization may be comprised of multiple teams, with each team having a website 144-1, 144-2, 144-j pulling data from the cloud 210-k. Although not shown in FIG. 2, embodiments provide for management user interfaces 142-i comprising websites configured to push data to the cloud 210-k. For example, in one embodiment, certain organization information 180-e may be set up from a cloud-based management user interface 142-i, such as a website for setting up games or team schedules. According to embodiments, the cloud 210-k may be comprised of servers 110-a, 120-b, third party information sources, or some combination thereof. In one embodiment, each organization may have at least one unique viewing user interface 144-j (such as websites 144-1, 144-2) for accessing and managing associated data 180-e, 182-f, regardless of whether the data is stored in the cloud 210-k, servers 110-a, 120-b, or some combination thereof.

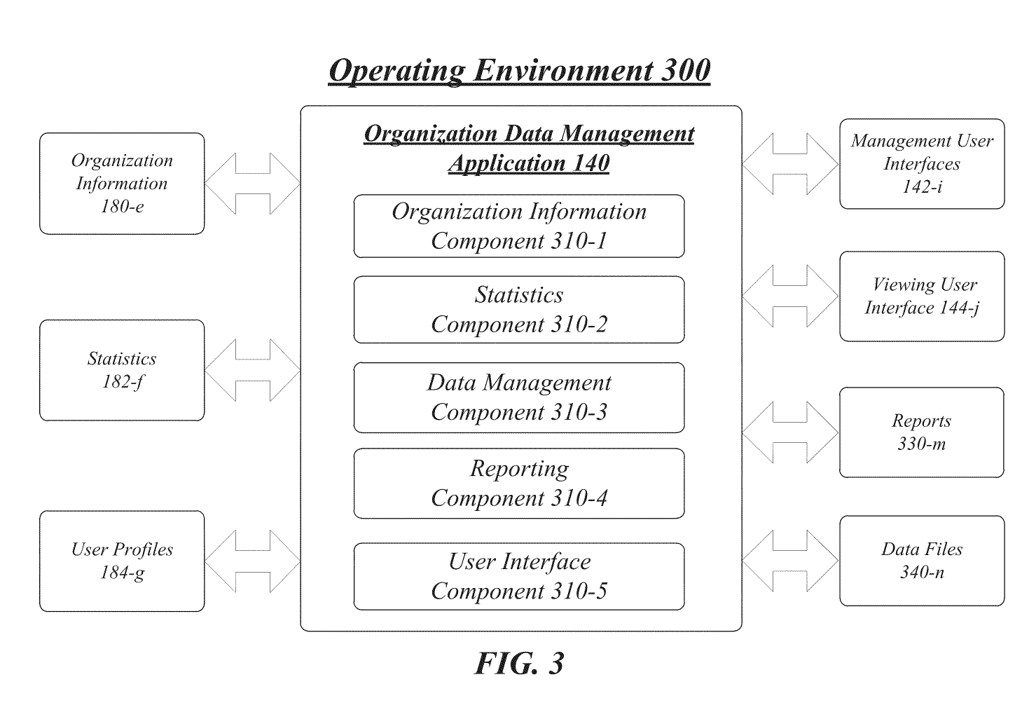

Particular aspects, embodiments and alternatives of the organization data management system 100 and the organization data management application 140 may be further described with reference to FIG. 3.

FIG. 3 illustrates an embodiment of an operating environment 300 for the organization data management system 100. More particularly, the operating environment 300 may illustrate a more detailed block diagram for the organization data management application 140.

As shown in FIG. 3, the organization data management application 140 may comprise various components 310-1. As used in this application, the term “component” is intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In the illustrated embodiment shown in FIG. 3, the organization data management application 140 may comprise an organization information component 310-1, a statistics component 310-2, a reporting component 310-4, a data management component 310-3, and a user interface component 220-5. Although the organization data management application 140 shown in FIG. 2 has only four components in a certain topology, it may be appreciated that the organization data management application 140 may include more or less components in alternate topologies as desired for a given implementation. The embodiments are not limited in this context. In one embodiment, each report 330-m may be associated with a report definition file (XSL file) that operates like HTML and may be modified as such. Report elements, such as fonts, colors and other style information may be stored in cascading style sheet (CSS) files, for example, all the header colors in all reports may be changed by changing the one master CSS file.

The organization information component 310-1 may generally receive and manage organization information 180-e. The organization information 180-e may be entered via one or more management user interfaces 142-i accessible from a display 132 of a client 130-c. The management user interfaces 142-i may be configured to allow data entry of information pertaining to organizations affiliated with the organization data management system 100. For example, certain management user interfaces 142-i may be configured for a specific organization entity, such as an athletic league, for entry of associated information, such as teams, team locations and stadiums, number of games, schedules, rules, administrators, while others may be configured for teams and entry of information such as rosters, players, names, jersey numbers, positions, number of years with team, and the like. The organization information component 310-1 may operate to manage the organization information 180-e by establishing and maintaining data relationships between the organization information 180-e elements, the organization entities, and administrators. For instance, the organization information component 310-1 may manage data sharing and validation of data among organization entities (e.g., athletic conferences or teams).

The statistics component 310-2 may generally operate to receive and manage statistics 182-f. The statistics 182-f may be entered via one or more management user interfaces 142-i accessible from a display 132 of a client 130-c. The management user interfaces 142-i may be configured to provide for efficient entry of statistics 182-f for each organization entity or event. For example, entry of statistics 182-f for a baseball game may require different data entry features than that for a basketball game. As such, the statistics component 310-2 may provide one or more management user interfaces 182-f specific for the type of organization entity or event associated with the statistics.

The data management component 310-3 may generally operate to provide data management functions for the organization data management application 140. Exemplary and non-limiting data management functions include data import, data export, file creation, pushing/pulling data to/from the cloud 210-k or to/from servers 110-a, 120-b, data validation, and data sharing. According to embodiments, the organization information 180-e and the statistics 182-f may be stored in a database or as files in various formats as data files 340-n. Illustrative and non-restrictive examples of data files 340-n include extensible markup language (XML), hypertext markup language (HTML), text document formats (e.g., .txt, .rtf, .doc. .docx), spreadsheet formats (e.g., .csv, .xls), pack files (including pack files specific for each sport), cascading style sheets (CSS), database tables, multimedia files, and combinations thereof. For example, a user may access the organization data management application 140 and request to export data in a specific file format to a local device 130-c, such as the season statistics for a particular college hockey team in a spreadsheet document format from data contained within the cloud 210-k. In this manner, organization data 180-e and statistics 182-f may be considered “local” (e.g., stored on a client device 130-c) or non-local, such as being in a “downloaded” state and being stored on a server 110-a, 120-b, or in a “cloud” state and being stored on the cloud 210-k.

The data management component 310-3 may operate to relate the statistics 182-f to the organization information 180-e. For example, each statistic 182-f entered into the organization data management system 100 must be associated with at least one organization information 180-e element, such as a player, team, or game. In addition, the data management component 310-3 may draw relationships between organization information 180-e elements to provide for the affiliation of statistics 182-f among all related information 180-e elements. For example, if a player scores a touchdown in a game, the touchdown may be associated with the player, the team (e.g., for team totals), the league, etc.

According to embodiments, the data management component 310-3 may operate to provide automatic data backup and data synchronization functions, for example, for connected computing devices 110-a, 120-b, and 130-c (e.g., connected to each other or the cloud 210-k). In one embodiment, the data management component 310-3 may automatically backup and/or synchronize client 130-c data for clients 130-c connected to the cloud 210-k or servers 110-a, 120-b. For example, when a client 130-c connects to the organization data management application 140 operating on server 110-a or connects to the cloud 210-k to score a game, all relevant organization information 180-e for scoring the game may be pushed to the client 130-c to allow the client 130-c to score the game. In one embodiment, the data management component 310-3 may manage to operate one or more data transfer services associated with organizations, such as an file transfer protocol (FTP) site, for example, as a temporary or permanent destination for statistics 182-f.

The reporting component 310-4 may generally operate to provide reports 330-m comprising organization information 180-e, statistics 182-f, or both. In one embodiment, a viewing user interface 144-j may be configured to provide reporting features for generating reports 330-m involving one or more organization entities, such as a team, a game, a league, or a player. A user with the correct privileges as specified in an associated user profile 184-g may access the viewing use interface 144-j, specify report parameters, and generate a report 330-m (e.g., by selecting a “run report” virtual button). The reporting component 310-4 may access the organization information 180-e and the statistics 182-f stored in a database 190-h, for example, in server 120-b or in the cloud 210-k, based on the parameters. For example, the viewing user interface 144-j may be focused on a particular athletic league, and the parameters may specify the total statistics for a team within the particular athletic league for the past three seasons. Reports 330-m generated by the reporting component 310-4 may be displayed or otherwise accessible from a viewing user interface 144-j or management user interface 142-j.

The user interface component 310-5 may generally operate to facilitate user access to the organization data management application 140 and the data contained therein. Users may access one or more management user interfaces 142-i and/or viewing user interface 144-j to interact with organization information 180-e, statistics 182-f, reports 330-m, or data files 340-n. In general, the management user interfaces 142-i may be utilized for functions involving entering, editing, manipulating, or otherwise modifying organization information 180-e or statistics, or the structure of same. The viewing user interfaces 144-j, for the most part, are configured to provide access to the data 180-e, 182-f without allowing for the actual manipulation (e.g., editing, adding, deleting, etc.) of any data. For example, a viewing user interface 144-j may comprise a website for viewing organization information 180-e and statistics 182-f for a particular baseball team, including filtering the data 180-e, 182-f and generating reports 330-m, but without making any changes to the set of data 180-e, 182-f as stored within the organization data management system 100. A management user interface 142-i, on the other hand, may provide user interface elements for modifying data 180-e, 182-f, such as entering the statistics 182-f for a game. In one embodiment, the user interface component 310-5 may allow access to each user interface 142-i, 144-j based on security credentials provided in user profiles 184-g associated with the users.

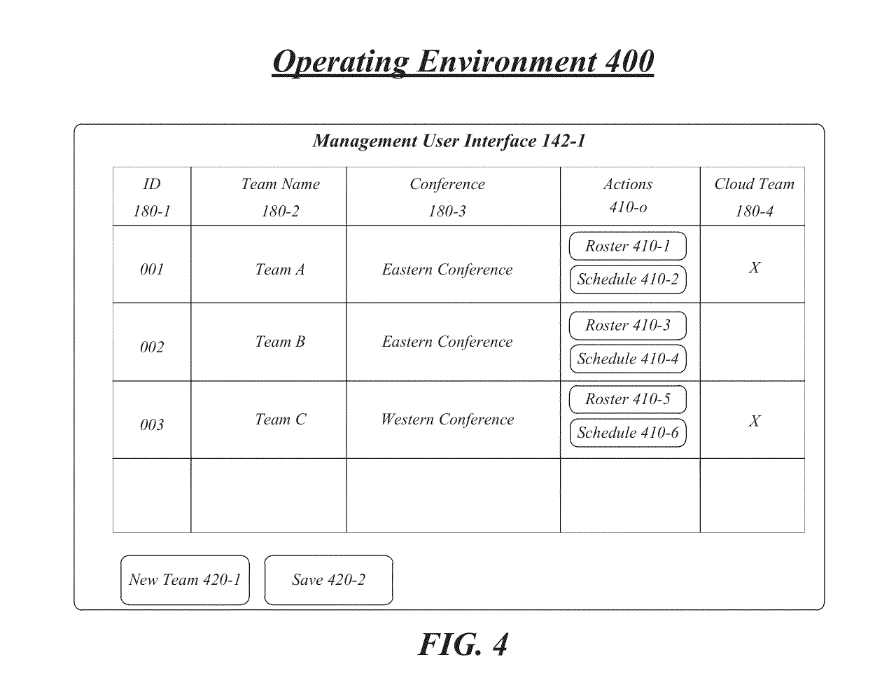

FIG. 4 illustrates an embodiment of an operating environment 400 for the organization data management system 100. More particularly, the operating environment 400 may illustrate an exemplary management user interface 142-i configured according to an embodiment. The management user interface 142-1 may be utilized to view and manage certain organization entities, such as teams, leagues, or conferences. The management user interface 142-1 may be associated with certain organization information, such as entity identifiers 180-1, team names 180-2, organization entities 180-3, and whether data associated with an entity may be located within the cloud 210-k 180-4. One or more actions 410-o may be available from the management user interface 142-1, for example, to edit organization information 180-e associated with an organization entity. In the example depicted in FIG. 4, the actions 410-o may allow an administrator to edit the roster 410-1, 410-3, 410-5 of a team or the schedule 410-2, 410-4, 410-6 of a team or conference. Additional functions 420-p may be associated with the management user interface 142-1, such as adding a new team 420-1 and saving 420-2 the data, for example, to a server 110-a, 120-b or the cloud 210-k.

According to embodiments, management user interfaces 142-i, such as management user interface 142-1, may be utilized to manage all types of organization information 180-e, such as rosters, players, teams, sports, schedules, etc. In this manner, each type of organization information 180-e may be edited, added, deleted, or otherwise modified from one or more management user interfaces 142-i. Due to vast number of types and configurations of organization information 180-e, all potential management user interfaces 142-i are not depicted herein to prevent repetition and obfuscation. The management user interface 142-1 provides an example of management user interfaces 142-1, such as a player user interface and a team user interface, that may be utilized to carry out the embodiments as described herein. Embodiments are not limited in this context.

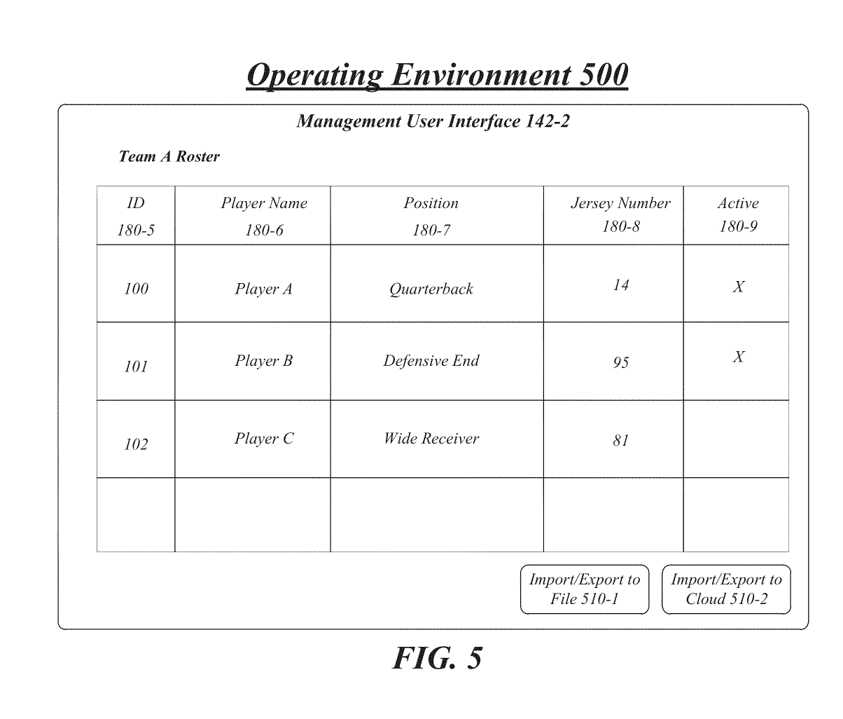

FIG. 5 illustrates an embodiment of an operating environment 500 for the organization data management system 100. More particularly, the operating environment 500 may illustrate an exemplary management user interface 142-i configured according to an embodiment. The management user interface 142-2 depicted in FIG. 5 may be utilized to manage a team roster, for example, as a result of selecting the roster 410-1 action of FIG. 4. The management user interface 142-2 may be associated with certain organization information 180-e, such as a player identifier 180-5, names 180-6, positions 180-7, jersey numbers 180-8, and whether a player is active 180-9. According to embodiments, a user may make a selection of organization information 180-5, 180-6, 180-7, 180-8, 180-9 and may edit data associated therewith, such as through a popup window or other such data entry screen. Data functions 510-q may be associated with the management user interface 142-2, such as an import/export to file 510-1 function configured to export organization data 180-e associated with the management user interface 142-2 to a specified file type. Another function may provide for importing/exporting the organization data 180-e to the cloud 210-k 510-2. Embodiments provide that these, and other functions described herein, are not limited to the particular user interface 142-i, 144-j for which they are described, as they may be associated with any user interface 142-i, 144-j contemplated herein. Embodiments are limited in this context.

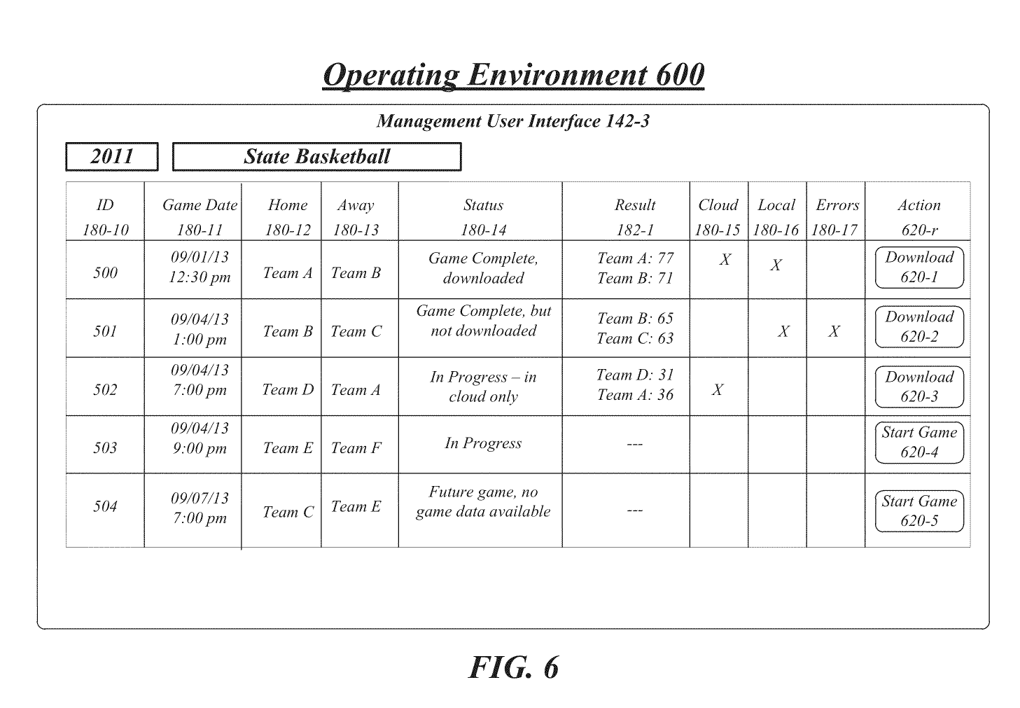

FIG. 6 illustrates an embodiment of an operating environment 600 for the organization data management system 100. More particularly, the operating environment 600 may illustrate an exemplary management user interface 142-i configured according to an embodiment. The management user interface 142-3 depicted in FIG. 6 may be configured to manage one or more events for an organization, such as games for a basketball league. The management user interface 142-3 may be associated with certain organization information 180-e, such as a game identifier 180-10, dates and times 180-11, a home team 180-12, an away team 180-13, a game and data status 180-14, indicators as to whether data is located in the cloud 210-k and/or locally 180-15, 180-16, whether the data contains errors 180-17. Each game may be associated with statistics 182-f, such as a game score 182-1, and one or more actions 620-r. According to embodiments, exemplary actions 620-r may include downloading the data 620-1, 620-2, 620-3 and starting a game 620-4, 620-5. The availability of an action 620-r may be dependent upon the status 180-14 of the game. For example, data for a game may not be downloaded 620-1, 620-2, 620-3 until the game has been started.

With respect to errors 180-17, an optional error checking component (not shown) may be implemented as part of the organization data management application 140 to monitor and check for errors in any data used by the organization information component 310-1 and/or statistics component 310-2. The data may be received as input from one or more users or some third-party administrator, auto-generated data, data retrieved from a database, third-party data sources, and so forth. For example, as previously described, a management user interface 142-i may provide user interface elements for modifying data 180-e, 182-f, such as entering organization information 180-e or statistics 182-f for a game. The error checking component may surface such errors as part of the management user interface 142-3, automatically correct such errors, or perform some combination thereof. For instance, assume multiple users were entering a set of statistics 182-1, 182-2 for a same game of an under seven (U7) soccer team. The error checking component may compare the set of statistics 182-1, 182-2 to identify and resolve any errors. Any suitable error checking and correcting techniques may be utilized for various implementations, and the embodiments are not limited in this context.

In some cases, such as when receiving data from different sources, the error checking component may additionally or alternatively perform data normalization for any received data in an attempt to ensure data consistency and compatibility before, after or during error correcting operations. For instance, the error checking component may adjust received values measured on different scales to a notionally common scale. In more complicated cases, the error checking component may utilize more sophisticated adjustments in an attempt to bring entire probability distributions of adjusted values into alignment. Any suitable normalization techniques may be utilized for various implementations, and the embodiments are not limited in this context.

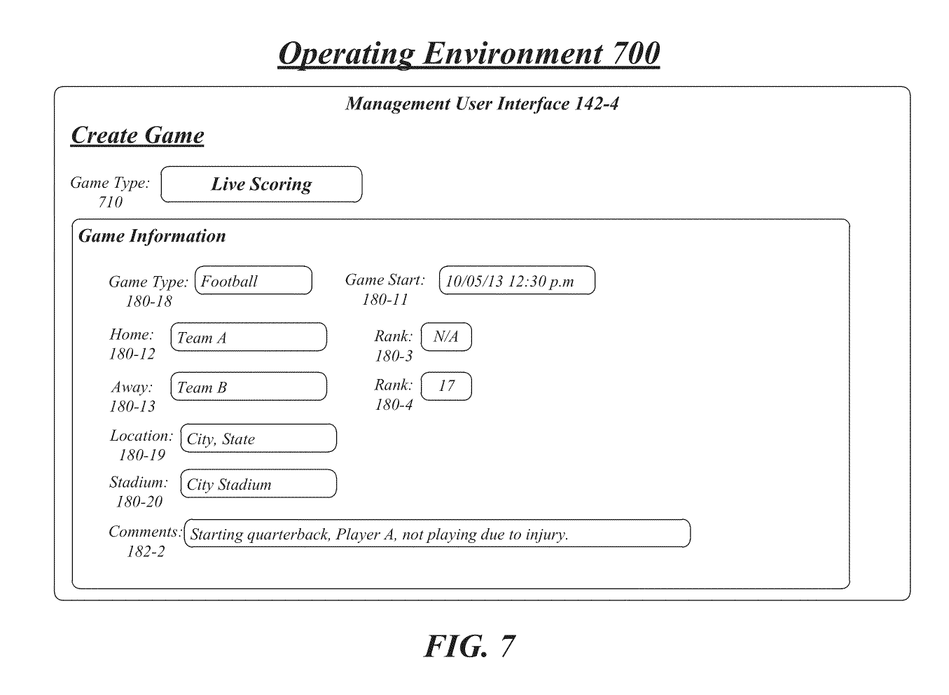

FIG. 7 illustrates an embodiment of an operating environment 700 for the organization data management system 100. More particularly, the operating environment 700 may illustrate an exemplary management user interface 142-i configured according to an embodiment. The management user interface 142-4 depicted in FIG. 7 may be configured to create a game, such as the games depicted in the management user interface 142-3 of FIG. 6. For each game, the type of scoring 710 may be specified, such as live scoring, box scoring, or importing data. Creating a game through the management user interface 142-4 may provide for the entry of organization information 180-e and statistics 182-f associated with the game. For example, each game may be associated with a game type 180-18, home team 180-12, away team 180-13, location 180-19, stadium 180-20, and game start 180-11 information, and comments 182-2 and team rank 182-3, 182-4 statistics. Additional organization information may be required before a game may be created, for instance, such as the game starters and their positions. Embodiments are not limited in this context.

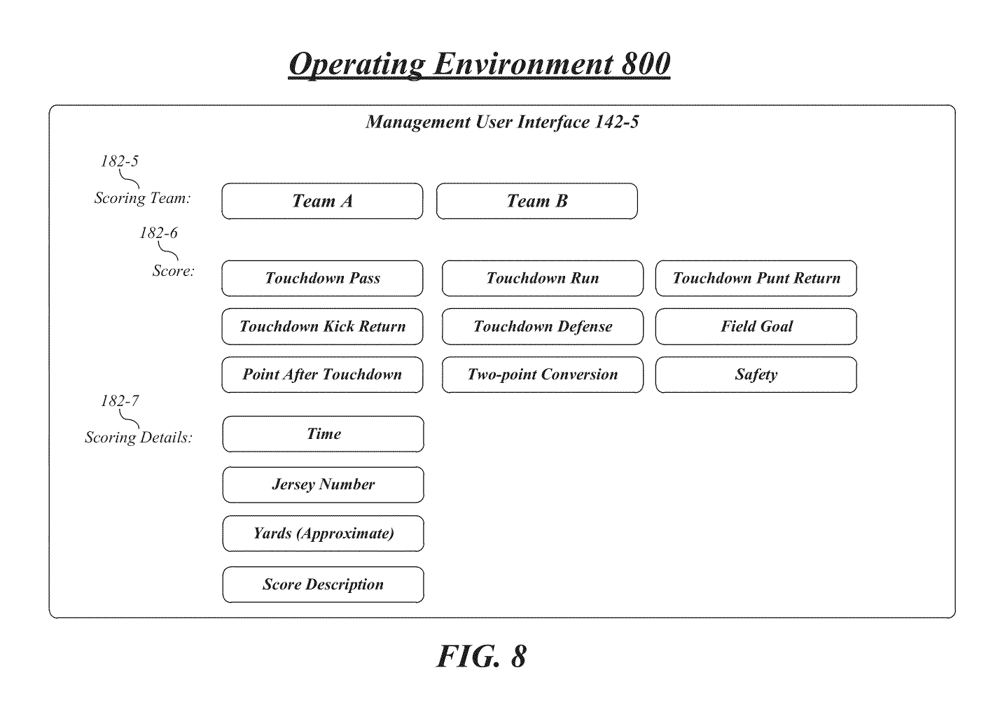

FIG. 8 illustrates an embodiment of an operating environment 800 for the organization data management system 100. More particularly, the operating environment 800 may illustrate an exemplary management user interface 142-i configured according to an embodiment. The management user interface 142-5 depicted in FIG. 8 may comprise an interface to enter scoring information for an event associated with an organization entity, such as a game. In the example embodiment depicted in FIG. 8, the event comprises a football game. Multiple graphical user interface elements of the management user interface 142-5 may be used to enter statistics 182-f for the game, such as the scoring team 182-5, the score 182-6, and scoring details 182-7. According to embodiments a game may be scored with live scoring, or by manually entering a box score. Embodiments are not limited to the management user interface 142-5 depicted in FIG. 8 as any user interface configuration suitable for entering statistics 182-f for scoring a game is contemplated herein. Embodiments are not limited in this context. Statistics 182-f entered via a management user interface 142-i, such as management user interface 142-5, may be communicated to the statistics component 310-2 for management within the organization data management application 140.

In one embodiment, scoring information may be entered according to a management user interface 142-i, such as management user interface 142-5, in combination with one or more mapped keys. The mapped keys may be general (e.g., F1 indicates a score, followed by the number and selection of the ENTER key to indicate the number of points). Other mappings may include the H and V keys to set the currently selected team to home and visitor, respectively; the SPACE key to start/stop the clock; F2 to edit the roster for a team; F3 to manage or change the current period; the F4 and F5 keys to start and end the period, respectively; F6 to substitute players in or out of the game; F7 to edit the current clock time; and ESC to clear the current play. These key mappings are illustrative and non-restrictive examples. Embodiments are not limited in this context. In addition, embodiments provide that each sport may be associated with a set of mapped hot-keys for entering statistics 182-f, such as scores and scoring details. For example, embodiments may utilize the following hot-keys for soccer play types: S—shot attempt; E—header attempt; K—corner kick; Y—yellow card; C—comment; T—timeout; F—foul; O—offside; R—red; Z—shootout; G—change goalie; I—sub in; and P—penalty kick. In another example, embodiments may utilize the following hot-keys for soccer play details: S—save by goalie; G—goal; B—blocked; O—own goal; L—left; R—right; H—high; W—wide; P—post; C—cross bar; T—team save; D—defensive player save; Corner—the input for a corner kick may be the team and jersey number of the player. These hot-keys are illustrative and non-restrictive, as any hot-keys may be utilized and associated with any organization information 180-e and statistics 182-e according to embodiment provided herein. Embodiments are not limited in this context.

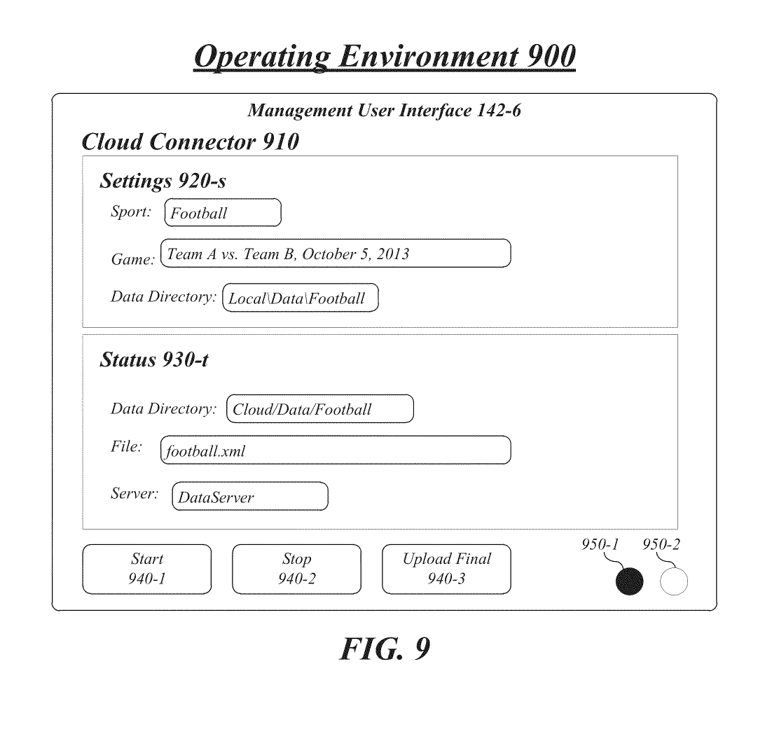

FIG. 9 illustrates an embodiment of an operating environment 900 for the organization data management system 100. More particularly, the operating environment 900 may illustrate an exemplary management user interface 142-i configured according to an embodiment. The management user interface 142-6 depicted in FIG. 9 provides functions to connect with the cloud 210-k from within the organization data management application 140 for data management purposes. The management user interface 142-6 may comprise a cloud connector 910 configured to connect with a cloud 210-k. The cloud connector 910 may be comprised of settings 920-s and status 930-t information. In one embodiment, the settings 920-s may specify connection information and data specifics, such as the specific information in the cloud 210-k for the connection. Exemplary settings 920-s may include a sport, an event, and a data directory. Status 930-t information may comprise information pertaining to the status of the connection with the cloud 210-k, such as cloud data directories, data files, and servers. The management user interface 142-6 may provide certain functions 940-u, such as starting the connection 940-1, stopping the connection 940-2, and uploading/downloading data 940-3. Certain connection indicators 950-v may be utilized to indicate a state of the connection, such as whether the connection has been established 950-1, or whether data transfer is active 950-2. According to embodiments, establishing a connection to the cloud 210-k may provide for certain automatic data functions, such as automatic data backup and data synchronization facilitated by the cloud 210-k and aspects of the organization data management application 140, such as the data management component 310-3.

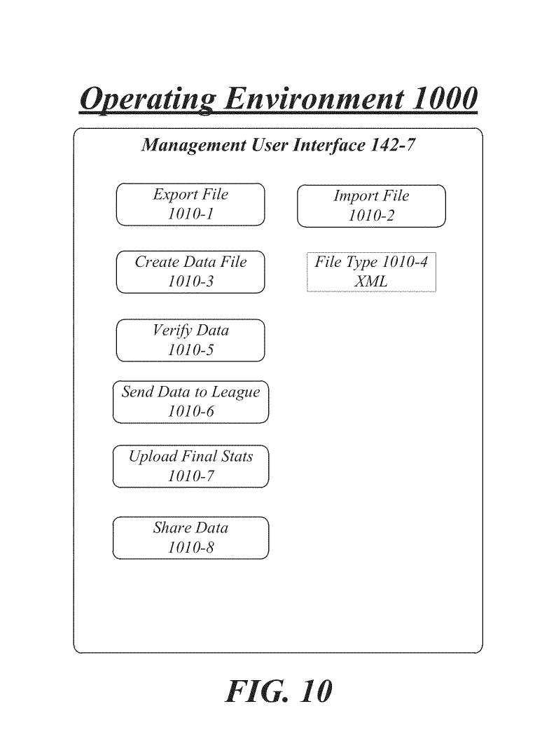

FIG. 10 illustrates an embodiment of an operating environment 1000 for the organization data management system 100. More particularly, the operating environment 1000 may illustrate an exemplary management user interface 142-i configured according to an embodiment. The management user interface 142-7 depicted in FIG. 10 may provide data management functions 1010-w for managing organization information 180-e and/or statistics 182-f and associated data structures, such as data files. For example, the management user interface 142-7 may comprise functions to export a file 1010-1, import a file 1010-2, create a data file 1010-3, specify a file type 1010-4 (e.g., for export, import, or file creation), verify data 1010-5, send data to an organization entity 1010-6, upload data 1010-7, and share data 1010-8.

In one embodiment, each organization may be associated with a central organization entity. For example, a collegiate athletic team may be associated with a central authority, such as the NCAA®, or a high school team may be associated with a regional school athletic association. The central authority may receive data 180-e, 182-f from organization entities for central management and/or administration. The data management component 310-3 may provide functionality, such as the send data to league 1010-6 function, to send the data in the correct format to a central organization. In one embodiment, data 180-e, 182-f may be verified, for example, for errors. As such, the data management component 310-3 may comprise rules, example data, and standards used to verify that data conforms and does not have errors. According to embodiments, a user may verify the statistics 182-f entered for an event before uploading (e.g., to the cloud 210-k), sending to a central organization, downloading to a local device (e.g., client 130-c), or performing any other actions with the statistics 182-f. In this manner, the organization data management application 140 may operate to ensure the integrity and viability of its data 180-e, 182-f. Users and organization entities may share data within the organization data management system 140. As such, the data management component 340 may operate to handle data sharing functions, for example, through parameters indicating which entities may share information, which information may be shared, and which user profiles 184-g have the privileges to share data 180-e, 182-f.

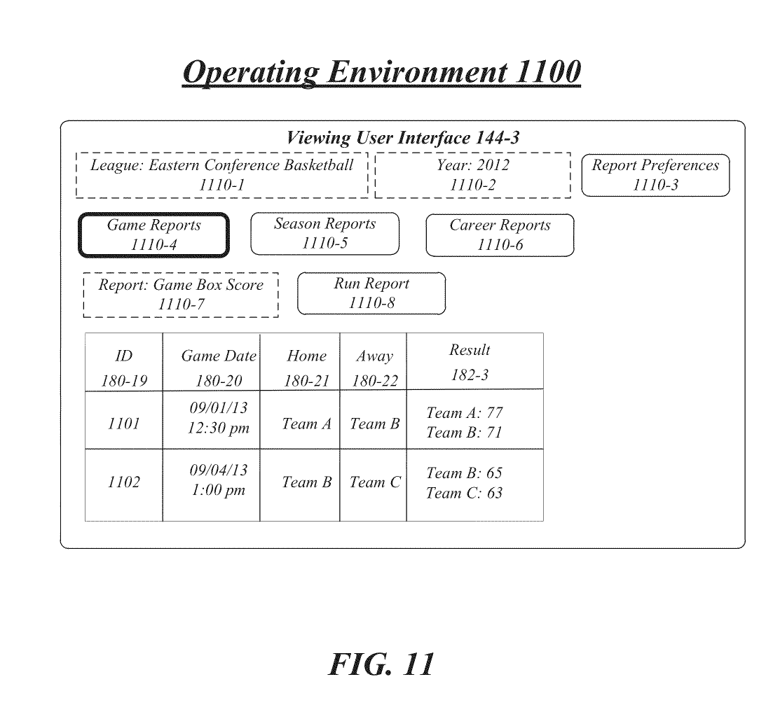

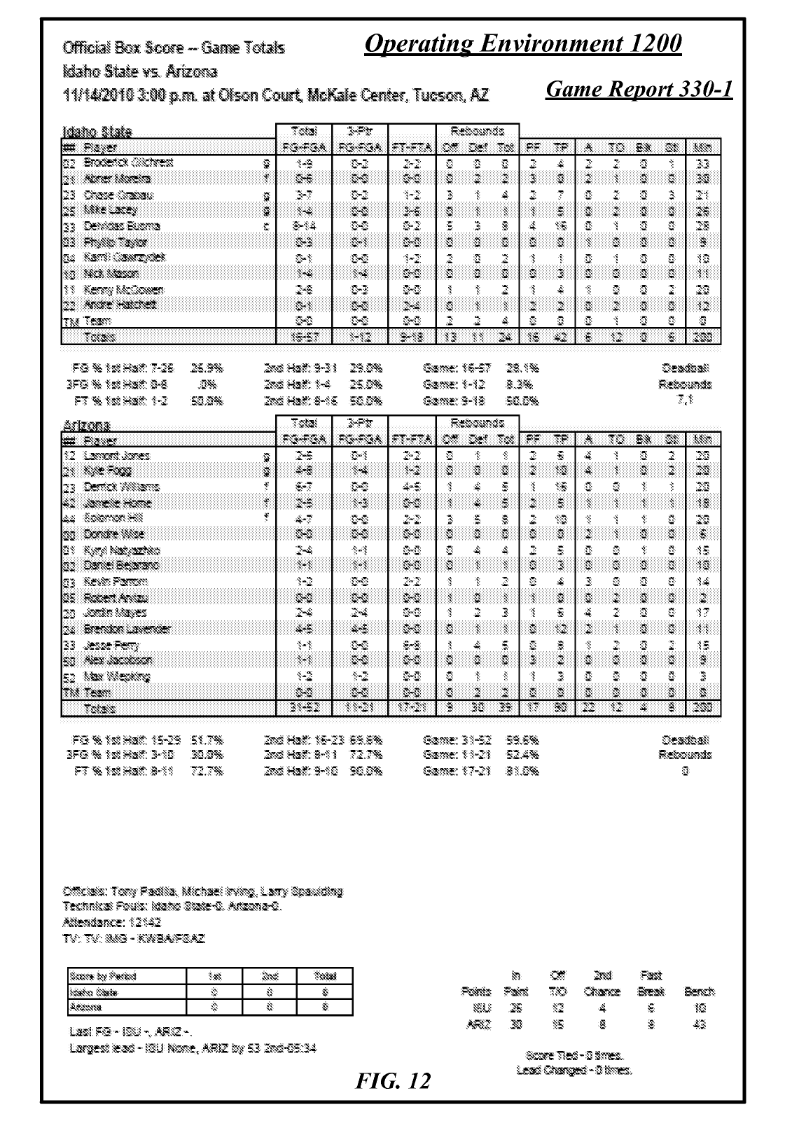

FIG. 11 illustrates an embodiment of an operating environment 1100 for the organization data management system 100. More particularly, the operating environment 1100 may illustrate an exemplary viewing user interface 144-j configured according to an embodiment. The viewing user interface 142-3 depicted in FIG. 5 provides access to certain reporting functions 1110-x within the organization data management application 140. A user may access the viewing user interface 142-3 and specify an organization entity 1110-1, a year 1110-2, as well as certain report preferences 1110-3. According to embodiments, report preferences 1110-3 may include report destination, file type, general presentation information, and data filtering options. Reporting functions 1110-x may also provide selection of the level of detail of a report 330-m, such as reporting data 180-e, 182-f at the game level 1110-4, the season level 1110-5, or the player career level 1110-6, and the structure of the report 1110-7, such as whether the report 330-m may be presented as a box score or a play-by-play format. As the user configures the report 330-m, organization information 180-e and statistics 182-f relevant to the selections may be presented on the viewing user interface, such as a data identifier 180-21, a game date 180-11, a home team 180-12, an away team 180-13, and statistics 1821, such as a final result 180-1. The user may select to run the report 1110-8 to generate the report 330-m. The reporting component 310-4 may access the data 180-e, 182-f associated with the specified report configuration, and generate a report 330-m, for example, as an HTML web page. Referring now to FIG. 12, therein is provided an exemplary report 330-1 configured according to embodiments provided herein.

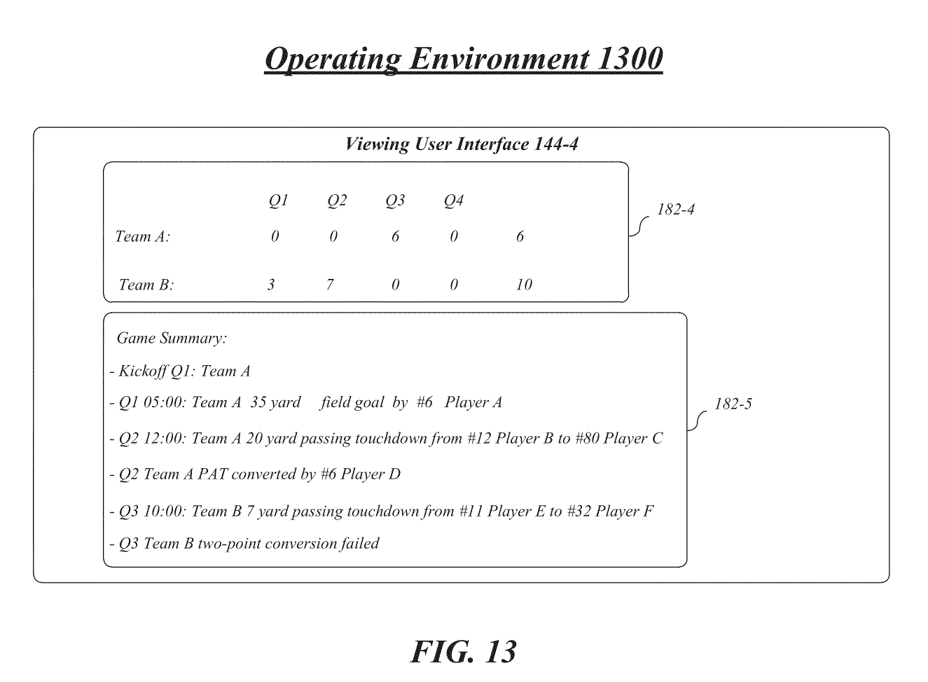

FIG. 13 illustrates an embodiment of an operating environment 1300 for the organization data management system 100. More particularly, the operating environment 1300 may illustrate an exemplary viewing user interface 144-j configured according to an embodiment. The viewing user interface 144-4 depicted in FIG. 13 provides an exemplary user interface presenting statistics 182-f for an event on a website. In the example of FIG. 13, the event is a football game and the presented statistics 1821 comprise a box score type 182-4 and a play-by-play type 182-5. The user interface component 310-5 may access data 180-e, 182-f as specified by the viewing user interface 144-4, for example, as designed by a user or configured by the user interface component 310-5 based on the data being displayed. The viewing user interface 144-4 may be accessed by a user via the display 132 of a client 130-c. The example embodiment of FIG. 13 is for illustrative purposes only and is non-restrictive. Embodiments presented herein contemplate any type of viewing user interface 144-j capable of presenting organization data management system 100 data 180-e, 182-f. Embodiments are not limited in this context.

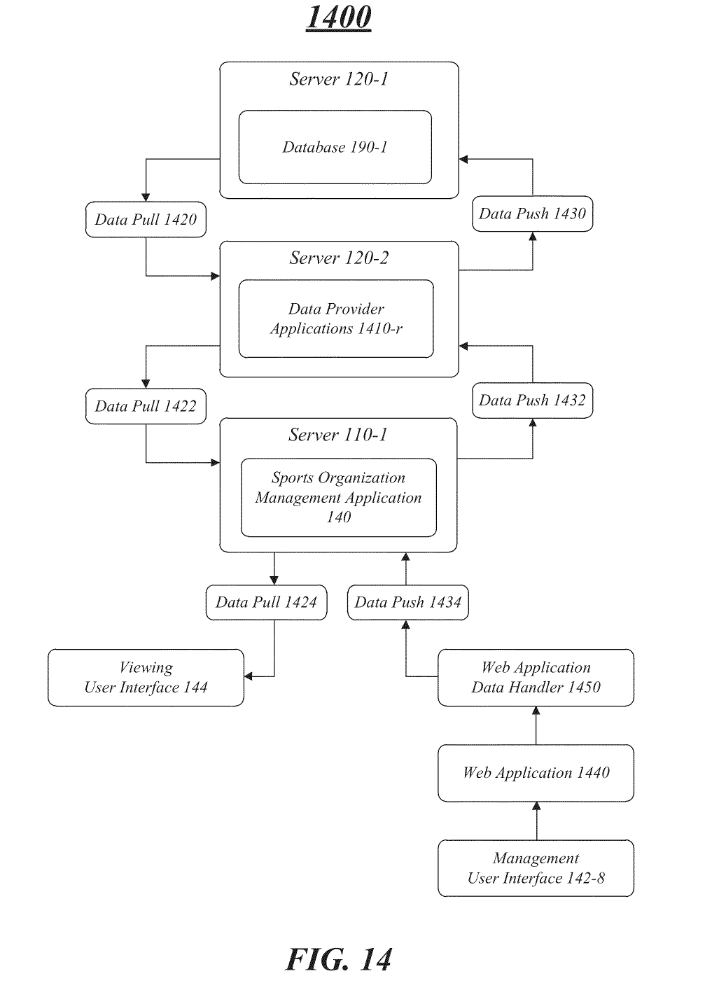

Referring to FIG. 14, therein is provided an embodiment of an operating environment 1400 for the organization data management system 100. As shown in FIG. 14, the organization data management system 100 may be comprised of or in communication with a database 190-1 and one or more data provider applications 1410-k operating on one or more servers 120-1, 120-2. According to embodiments, the database 190-1 may be an SQL database and the one or more data provider applications 1410-k may be comprised, at least in part, of a .NET web services layer. The database 190-1 and the one or more data provider applications 1410-k may interact through data pull 1420 and push operations 1430.

The organization data management application 140 may operate on a server 110-1 and may obtain data from the one or more data provider applications 1410-k through one or more data pull 1422 and push 1432 operations. The viewing user interface 144-j may pull data 1424 from the live event reporting application 140, which pulled 1422 the data from the one or more data provider applications 1420-k. Organization information 180-e entered through a management user interface 142-i may be submitted utilizing a web application 1440 that communicates with a web application data handler 1450 configured to push 1434 data to the organization data management application 140. In one embodiment, the management user interface 142-i and the viewing user interface 144-j may be comprised of ASP.NET web pages, wherein the management user interface 142-i may submit game data via Asynchronous JavaScript and extensible markup language (XML) (AJAX). In this embodiment, the web application data handler 1450 may comprise a .NET web handler script (e.g., an .ashx file), which may accept data via a hypertext transfer protocol (HTTP) post.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

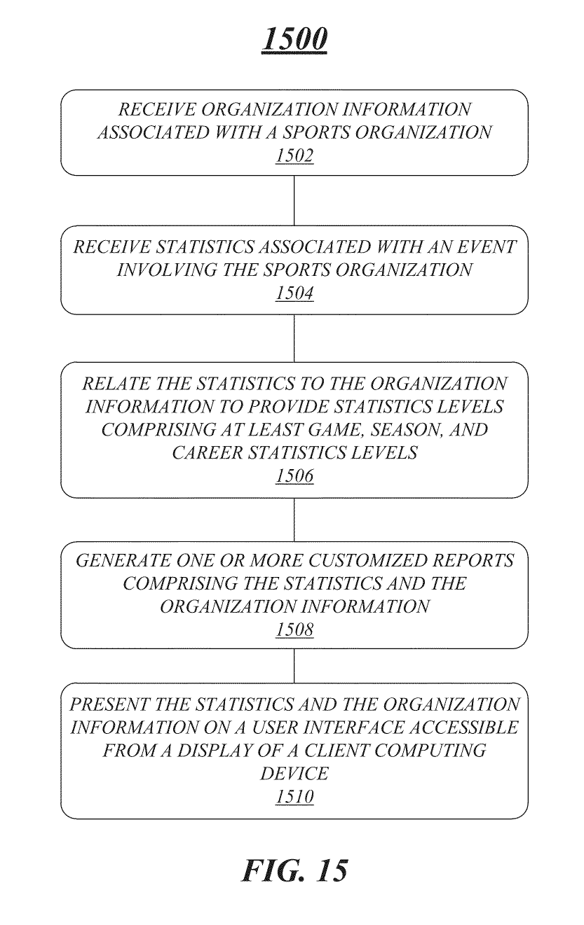

FIG. 15 illustrates one embodiment of a logic flow 1500. The logic flow 1500 may be representative of some or all of the operations executed by one or more embodiments described herein. For example, the logic flow 1500 may illustrate operations performed by the organization data management system 100. More specifically, the logic flow 1500 provides an example embodiment for receiving, generating, reporting, and managing data 180-e, 182-f within the organization data management application 150.

In the illustrated embodiment shown in FIG. 15, the logic flow 1500 may receive organization information associated with a sports organization at block 1502. For example, organization information 180-e may be entered from a management user interface 142-i presented on a display 132 of a client 130-b. The server 110-a may receive the organization information 180-e via a transceiver 170-d for communication to the organization information component 310-1 of the organization data management application 140. The organization information 180-e may be utilized by the organization data management application 140 operating on the server 110-a or may be stored in a database 190-h on server 120-b or in a cloud 210-k accessible by the organization data management application 140.

The logic flow 1500 may receive statistics associated with an event involving the sports organization at block 1504. For example, statistics 182-f may be entered from a management user interface 142-i presented on a display 132 of a client 130-b. The server 110-a may receive the organization information 180-e via a transceiver 170-d for communication to the statistics component 310-2 of the organization data management application 140. The statistics 182-f may be utilized by the organization data management application 140 operating on the server 110-a or may be stored in a database 190-h on server 120-b or in a cloud 210-k accessible by the organization data management application 140.

The logic flow 1500 may relate the statistics to the organization information to provide statistics levels comprising at least game, season, and career statistics levels at block 1506. The data management component 310-3 may operate to relate the statistics 182-f to the organization information 180-e. For example, each statistic 182-f entered into the organization data management system 100 must be associated with at least one organization information 180-e element, such as a player, team, or game. In addition, the data management component 310-3 may draw relationships between organization information 180-e elements to provide for the affiliation of statistics 182-f among all related information 180-e elements. For example, if a player hits a home run during a game, the home run may be associated with the player, the team (e.g., for team totals), the league, etc.

The logic flow 1500 may generate one or more customized reports comprising the statistics and the organization information at block 1508. For example, the reporting component 310-4 may operate to provide reports 330-m comprising organization information 180-e, statistics 182-f, or both. A user may configure and run reports from a viewing user interface 144-j configured to provide reporting features for generating reports 330-m. The reporting component 310-4 may access the organization information 180-e and the statistics 182-f stored in a database 190-h, for example, in server 120-b or in the cloud 210-k, based on the user configurations from the viewing user interface 144-j. Reports 330-m generated by the reporting component 310-4 may be displayed or otherwise accessible from a viewing user interface 144-j or management user interface 142-j.

The logic flow 1500 may present the statistics and the organization information on a user interface accessible from a display of a client computing device at block 1510. For example, the user interface component 310-5 may facilitate user access to the organization data management application 140 and the data contained therein. Users may access one or more management user interfaces 142-i and/or viewing user interface 144-j to interact with organization information 180-e, statistics 182-f, reports 330-m, or data files 340-n. In general, the management user interfaces 142-i may be utilized for functions involving entering, editing, manipulating, or otherwise modifying organization information 180-e or statistics, or the structure of same.

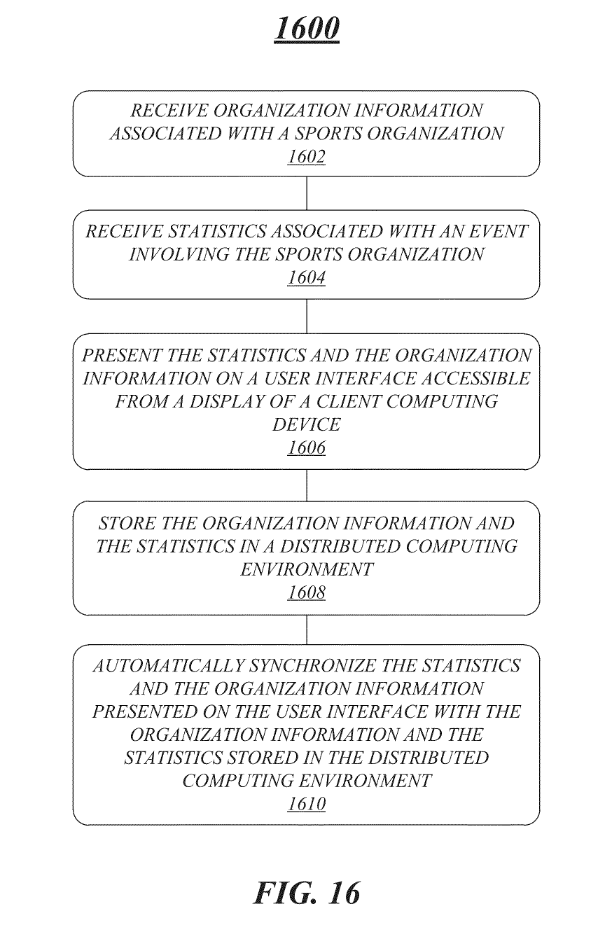

FIG. 16 illustrates one embodiment of a logic flow 1600. The logic flow 1600 may be representative of some or all of the operations executed by one or more embodiments described herein. For example, the logic flow 1600 may illustrate operations performed by the organization data management system 100. More specifically, the logic flow 1600 provides an example embodiment for receiving, generating, reporting, and managing data 180-e, 182-f within the organization data management application 140.

In the illustrated embodiment shown in FIG. 16, the logic flow 1600 may receive organization information associated with a sports organization at block 1602. For example, organization information 180-e may be entered from a management user interface 142-i presented on a display 132 of a client 130-b. The server 110-a may receive the organization information 180-e via a transceiver 170-d for communication to the organization information component 310-1 of the organization data management application 140. The organization information 180-e may be utilized by the organization data management application 140 operating on the server 110-a or may be stored in a database 190-h on server 120-b or in a cloud 210-k accessible by the organization data management application 140.

The logic flow 1600 may receive statistics associated with an event involving the sports organization at block 1604. For example, statistics 182-f may be entered from a management user interface 142-i presented on a display 132 of a client 130-b. The server 110-a may receive the organization information 180-e via a transceiver 170-d for communication to the statistics component 310-2 of the organization data management application 140. The statistics 182-f may be utilized by the organization data management application 140 operating on the server 110-a or may be stored in a database 190-h on server 120-b or in a cloud 210-k accessible by the organization data management application 140. The logic flow 1600 may at block 1606. For example,

The logic flow 1600 may present the statistics and the organization information on a user interface accessible from a display of a client computing device at block 1606. For example, the user interface component 310-5 may facilitate user access to the organization data management application 140 and the data contained therein. Users may access one or more management user interfaces 142-i and/or viewing user interface 144-j to interact with organization information 180-e, statistics 182-f, reports 330-m, or data files 340-n. In general, the management user interfaces 142-i may be utilized for functions involving entering, editing, manipulating, or otherwise modifying organization information 180-e or statistics, or the structure of same.

The logic flow 1600 may store the organization information and the statistics in a distributed computing environment at block 1608. For example, the data management component 210-k may operate to store organization information 180-e and statistics 1821 input into the organization data management application 140 into a cloud 210-k distributed computing environment. According to embodiments, the cloud 210-k may establish connections with clients 130-c such that a client 130-c may access cloud 210-k stored data, for example, from a management user interface 142-i or a viewing user interface 144-j.

The logic flow 1600 may automatically synchronize the statistics and the organization information presented on the user interface with the organization information and the statistics stored in the distributed computing environment at block 1608. For example, the data management component 310-3 may automatically synchronize client 130-c local data for clients 130-c connected to the cloud 210-k, or servers 110-a, 120-b. For example, when a client 130-c connects to the organization data management application 140 to access data 180-e, 182-f the data management component 310-3 may synchronize any changed data 180-e, 182-f between the cloud 210-k and the client 130-c local data.

In addition to, or alternative from, the above-described embodiments, the organization data management application 140 may be modified to implement various auto-narrative techniques designed to automatically generate narratives utilizing information provided to, and managed by, the organization data management system 100. For instance, assume organization information 180-e is received by the organization data management application 140 regarding a high school varsity soccer team named “Chargers,” as well as statistics 182-f for a game played against its conference rivals the “Ravens.” An auto-narrative component may be added to the organization data management application 140 to automatically generate a game summary of the Chargers-Ravens game for publishing on a web-site for one or both respective teams, a local newspaper, or some other distribution outlet. Examples of suitable auto-narrative components may be described in commonly-owned U.S. patent application Ser. Nos. 13/338,395 and 13/338,409, both of which are hereby incorporated by reference in their entirety. The embodiments, however, are not limited to these two examples.

As shown in FIG. 17, the computing architecture 1700 comprises a processing unit 1704, a system memory 1706 and a system bus 1708. The processing unit 1704 can be any of various commercially available processors, such as those described with reference to the processor circuit 150 shown in FIG. 1.

The system bus 1708 provides an interface for system components including, but not limited to, the system memory 1706 to the processing unit 1704. The system bus 1708 can be any of several types of bus structure that may further interconnect to a memory bus (with or without a memory controller), a peripheral bus, and a local bus using any of a variety of commercially available bus architectures. Interface adapters may connect to the system bus 1708 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1700 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 1706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 17, the system memory 1706 can include non-volatile memory 1710 and/or volatile memory 1712. A basic input/output system (BIOS) can be stored in the non-volatile memory 1710.

The computer 1702 may include various types of computer-readable storage media in the form of one or more lower speed memory units, including an internal (or external) hard disk drive (HDD) 1714, a magnetic floppy disk drive (FDD) 1716 to read from or write to a removable magnetic disk 1718, and an optical disk drive 1720 to read from or write to a removable optical disk 1722 (e.g., a CD-ROM or DVD). The HDD 1714, FDD 1716 and optical disk drive 1720 can be connected to the system bus 1708 by a HDD interface 1724, an FDD interface 1726 and an optical drive interface 1728, respectively. The HDD interface 1724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1710, 1712, including an operating system 1730, one or more application programs 1732, other program modules 1734, and program data 1736. In one embodiment, the one or more application programs 1732, other program modules 1734, and program data 1736 can include, for example, the various applications and/or components of the system 100.

A user can enter commands and information into the computer 1702 through one or more wire/wireless input devices, for example, a keyboard 1738 and a pointing device, such as a mouse 1740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1704 through an input device interface 1742 that is coupled to the system bus 1708, but can be connected by other interfaces such as a parallel port, IEEE 1394 serial port, a game port, a USB port, an IR interface, and so forth.

A monitor 1744 or other type of display device is also connected to the system bus 1708 via an interface, such as a video adaptor 1746. The monitor 1744 may be internal or external to the computer 1702. In addition to the monitor 1744, a computer typically includes other peripheral output devices, such as speakers, printers, and so forth.

The computer 1702 may operate in a networked environment using logical connections via wire and/or wireless communications to one or more remote computers, such as a remote computer 1748. The remote computer 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wire/wireless connectivity to a local area network (LAN) 1752 and/or larger networks, for example, a wide area network (WAN) 1754. Such LAN and WAN networking environments are commonplace in offices and companies, and facilitate enterprise-wide computer networks, such as intranets, all of which may connect to a global communications network, for example, the Internet.

When used in a LAN networking environment, the computer 1702 is connected to the LAN 1752 through a wire and/or wireless communication network interface or adaptor 1756. The adaptor 1756 can facilitate wire and/or wireless communications to the LAN 1752, which may also include a wireless access point disposed thereon for communicating with the wireless functionality of the adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wire and/or wireless device, connects to the system bus 1708 via the input device interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with wire and wireless devices or entities using the IEEE 802 family of standards, such as wireless devices operatively disposed in wireless communication (e.g., IEEE 802.11 over-the-air modulation techniques). This includes at least WiFi (or Wireless Fidelity), WiMax, and Bluetooth™ wireless technologies, among others. Thus, the communication can be a predefined structure as with a conventional network or simply an ad hoc communication between at least two devices. WiFi networks use radio technologies called IEEE 802.11x (a, b, g, n, etc.) to provide secure, reliable, fast wireless connectivity. A WiFi network can be used to connect computers to each other, to the Internet, and to wire networks (which use IEEE 802.3-related media and functions).

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, and so forth. The embodiments, however, are not limited to implementation by the communications architecture 1800.

As shown in FIG. 18, the communications architecture 1800 comprises includes one or more clients 1802 and servers 1804. The clients 1802 may implement the client device 150. The servers 1804 may implement summary engine device 110, and publication site 140. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 may communicate information between each other using a communication framework 1806. The communications framework 1806 may implement any well-known communications techniques, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The clients 1802 and the servers 1804 may include various types of standard communication elements designed to be interoperable with the communications framework 1806, such as one or more communications interfaces, network interfaces, network interface cards (NIC), radios, wireless transmitters/receivers (transceivers), wired and/or wireless communication media, physical connectors, and so forth. By way of example, and not limitation, communication media includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media. One possible communication between a client 1802 and a server 1804 can be in the form of a data packet adapted to be transmitted between two or more computer processes. The data packet may include a cookie and/or associated contextual information, for example.

The various elements of the organization data management system 100 as previously described with reference to FIGS. 1-18 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
creating, by a processor, a user profile for an organization data management system;
receiving organization information associated with a sports organization and the user profile;
relating statistics associated with one or more events involving the sports organization to the organization information, the statistics being related to provide statistics levels comprising at least game, season, and career statistics levels;
generating one or more customized reports comprising the statistics and the organization information; and
presenting the statistics and the organization information on a user interface accessible from a display of a client computing device.

2. The computer-implemented method of claim 1, the sports organization comprising at least one of:
a team;
a league; and
an athletic organization.

3. The computer-implemented method of claim 1, the organization information comprising at least one of:
a team;
a roster;
a player;
a game;
a schedule; and
a sport.

4. The computer-implemented method of claim 1, the statistics comprising at least one of:
a score;
score information;
scoring play;
time information; and
points.

5. The computer-implemented method of claim 1, the one or more events comprising at least one of:
a game;
a season;
a tournament;
a career.

6. The computer-implemented method of claim 1, further comprising storing the organization information and the statistics in a distributed computing environment.

7. The computer-implemented method of claim 6, further comprising automatically synchronizing the statistics and the organization information presented on the user interface with the organization information and the statistics stored in the distributed computing environment.

8. An apparatus, comprising:
a transceiver;
a processor circuit coupled to the transceiver; and
a memory unit coupled to the processor circuit, the memory unit to store organization data management application operative on the processor circuit to manage information for a sports organization, the organization data management application comprising:
an organization information component operative to receive, by the transceiver, organization information associated with a sports organization;
a statistics component operative to receive, by the transceiver, statistics associated with one or more events involving the sports organization;
a data management component operative to relate the statistics to the organization information, the statistics being related to provide statistics levels comprising at least game, season, and career statistics levels;
a reporting component operative to generate one or more customized reports comprising the statistics and the organization information; and
a user interface component operative to present the statistics and the organization information on a user interface accessible from a display of a client computing device.

9. The apparatus of claim 8, the sports organization comprising at least one of:
a team;
a league; and
an athletic organization.

10. The apparatus of claim 8, the organization information comprising at least one of:
a team;
a roster;
a player;
a game;
a schedule; and
a sport.

11. The apparatus of claim 8, the statistics comprising at least one of:
a score;
score information;
scoring play;
time information; and
points.

12. The apparatus of claim 8, the one or more events comprising at least one of:
a game;
a season;
a tournament;
a career.

13. The apparatus of claim 8, the data management component operative to store the organization information and the statistics in a distributed computing environment.

14. The apparatus of claim 13, the data management component operative to automatically synchronize the statistics and the organization information presented on the user interface with the organization information and the statistics stored in the distributed computing environment.

15. A non-transitory machine-readable storage medium comprising instructions that when executed cause a computing system to:
receive organization information associated with a sports organization;
relate statistics associated with one or more events involving the sports organization to the organization information, the statistics being related to provide statistics levels comprising at least game, season, and career statistics levels;
generate one or more customized reports comprising the statistics and the organization information; and
present the statistics and the organization information on a user interface accessible from a display of a client computing device.

16. The machine-readable storage medium of claim 15, the sports organization comprising at least one of:
a team;
a league; and
an athletic organization.

17. The machine-readable storage medium of claim 15, the organization information comprising at least one of:
a team;
a roster;
a player;
a game;
a schedule; and
a sport.

18. The machine-readable storage medium of claim 15, the statistics comprising at least one of:
a score;
score information;
scoring play;
time information; and
points.

19. The machine-readable storage medium of claim 15, the one or more events comprising at least one of:
a game;
a season;
a tournament;
a career.

20. The machine-readable storage medium of claim 15, comprising instructions that when executed cause the computing system to store the organization information and the statistics in a distributed computing environment.

21. The machine-readable storage medium of claim 20, comprising instructions that when executed cause a computing system to automatically synchronize the statistics and the organization information presented on the user interface with the organization information and the statistics stored in the distributed computing environment.

22. A computer-implemented method, comprising:
accessing, via a user interface accessible from a display of a client computing device, statistics and organization information associated with a sports organization, the statistics being associated with one or more events involving the sports organization, and being related to the organization information to provide statistics levels comprising at least game, season, and career statistics levels; and
customizing one or more customized reports comprising the statistics and the organization information from the user interface.

23. The computer-implemented method of claim 22, the sports organization comprising at least one of:
a team;
a league; and
an athletic organization.

24. The computer-implemented method of claim 22, the organization information comprising at least one of:
a team;
a roster;
a player;
a game;
a schedule; and
a sport.

25. The computer-implemented method of claim 22, the statistics comprising at least one of:
a score;
score information;
scoring play;
time information; and
points.
